(19) United States
(12) Patent Application Publication
(10) Pub. No.: US 2010/0021725 A1
(43) Pub. Date: Jan. 28, 2010

(54) ORGANOFUNCTIONAL SILICONE RESIN LAYERS ON METAL OXIDES

(75) Inventor: Torsten Gottschalk-Gaudig, Mehring (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/520,251

(22) PCT Filed: Dec. 14, 2007
(86) PCT No.: PCT/EP07/63921

§ 371 Date: Jun. 19, 2009

(30) Foreign Application Priority Data
Dec. 22, 2006 (DE) 10 2006 061 057.1

(51) Int. Cl. B32B 27/06

(52) U.S. Cl. 428/336; 428/447

(57) ABSTRACT

Pyrogenic silicic acid surface modified with a layer of a DT, DQ, or T silicone resin may be used in liquid media such as paints and coatings with little effect on the viscosity of the liquid.

The invention relates to the production of organofunctional resin layers on particulate metal oxides having a large specific surface area, the modified particulate metal oxides and the use thereof.

The use of organofunctionalized particulate solids, i.e. solids which are surface-modified with organic functional groups, for improving the mechanical properties of coatings, such as paints or finishes, or of adhesives and sealants is known. The aim of the organofunctionalization of particulate solids is the incorporation of said particles by chemical crosslinking into the polymer matrix of coating or adhesives and sealants. By means of the chemical incorporation by crosslinking in combination with a high content of particles, it is possible to improve the mechanical properties of coating or adhesives and sealants, such as scratch resistance, tensile strength, flexural strength, compressive strength, modulus of elasticity or impact resistance.

Owing to the high particle contents, however, the uncrosslinked coating materials, adhesives materials and sealing compounds have high viscosities or even viscoelastic solid-state properties. This can have a disadvantageous effect on the performance characteristics of the materials or can even make them completely unusable. By means of surface modification of the particles, the extent of the disadvantageous effects, such as high viscosity or viscoelastic solid-state properties, can be reduced, as described, for example in EP 1199337, but sufficiently low viscosities could only be achieved if the surface-modified particles used were additionally destructured by means of a ball mill. However, it was found that the particles modified according to the disclosed prior art lead to lower viscosities but these are still frequently too high so that disadvantageous effects occur in applications, such as, for example, coatings, such as, for example, poor leveling of the coating and associated surface defects. In addition, the destructuring of the particles, particularly in relatively high-viscosity binders, leads to an insufficient dispersing quality and hence to poor transparency of the resulting coatings.

DE 10207401 A1 describes the in situ modification of particles with organosilicon compounds. Here, however, it is found that the frequently insufficient chemical binding of the organosilicon compounds to the particle surface lead to disadvantages due to unbound organosilicon compounds.

It was an object of the invention to overcome the disadvantages of the prior art, in particular to provide particulate metal oxides which have only little influence on the viscosity and viscoelastic properties of a liquid medium.

The object is achieved by the invention.

The invention relates to modified particulate metal oxide, characterized in that it is surface-modified with an organofunctional silicone resin layer of the general formula I

(Y—(CH₂)ᵥ)_{w}Si(R¹)ₓ(OR²)_{y}O_{z/2} (I),

in which
R¹ is an optionally substituted Si—C-bonded C₁-C₂₀-hydrocarbon radical,
R² is a hydrogen atom or a hydrocarbon radical having the same meaning as R¹,
Y is a functional group —NR²₂, —OC(O)C(R)═CH₂ (R═H, C₁-C₁₅-hydrocarbon radical,
v is 1, 2 or 3,
w+x+y+z=4, it being possible for w, x, y and z to be any, including nonintegral, number <4.

It was surprising and by no means foreseeable for the person skilled in the art that particles which have only little influence on the viscosity and viscoelastic properties of liquids can be obtained by sufficiently permanent fixing of an organofunctional silicone resin layer having a defined composition on the particle surface, together with a sufficient thickness of the silicone resin layer.

The metal oxides according to the invention are surface-modified with an organofunctional silicone resin layer of the general formula I

(Y—(CH₂)ᵥ)_{w}Si(R¹)ₓ(OR²)_{y}O_{z/2} (I),

where the resin layer described by the general formula I may be composed of Q groups, T groups, D groups and M groups according to the formula QₛTₚDₖM_{g} and the composition of the resin layer can be described by the general formula II

(Si(OR²)ᵤO_{t/2})ₛ((Y—(CH₂)ᵥ)Si(OR²)ᵣO_{q/2})ₚ((Y—(CH₂)ᵥ)ₒSo(R¹)ₙ(OR²)ₘO_{1/2})ₖ((Y—(CH₂)ᵥ)ⱼSi(R¹)ᵢO_{1/2})ₕ (II),

the groups being composed according to

Q=(Si(OR²)ᵤO_{t/2}): (Si(OR²)₃O_{1/2})_{q}(Si(OR²)₂O_{2/2})_{f}(Si(OR²)O_{3/2})ₑ(SiO_{4/2})_{d}

T=((Y—(CH₂)ᵥ)Si(OR²)ᵣO_{q/2}): ((Y—(CH₂)ᵥ)Si(OR²)₂O_{1/2})_{c}((Y—(CH₂)ᵥ)Si(OR²)O_{2/2})_{b}((Y—(CH₂)ᵥ)SiO_{1/2})ₐ

D=((Y—(CH₂)ᵥ)ₒSi(R¹)ₙ(OR²)ₘO_{1/2}): ((Y—(CH₂)ᵥ)ₒSi(R¹)ₙ(OR²)O_{1/2})_{z′}((Y—(CH₂)ᵥ)ₒSi(R¹)ₙO_{2/2})_{y′}

M=((Y—(CH₂)ᵥ)ₖSi(R¹)ᵢO_{1/2}): ((Y—(CH₂)ᵥ)ⱼSi(R¹)ᵢO_{1/2})

in which
R¹ is an Si—C bonded C₁-C₂₀-hydrocarbon radical optionally substituted by —CN, —NCO, —NR²₂, —COOH, —COOR², -halogen, -acryloyl, -epoxy, —SH, —OH or —CONR²₂, preferably a C₁-C₈-hydrocarbon radical, particularly preferably a C₁-C₃-hydrocarbon radical, or an aryl radical, or a C₁-C₁₅-hydrocarbon-oxy radical, preferably a C₁-C₈-hydrocarbon-oxy radical, particularly preferably a C₁-C₄-hydrocarbon-oxy radical, in which in each case one or more non-neighboring methylene units can be replaced by groups —O—, —CO—, —COO—, —OCO— or —OCOO—, —S— or —NR²— and in which one or more non-neighboring methine units can be replaced by groups —N═, —N═N— or —P═,
R² is a hydrogen atom or hydrocarbon radical having the same meaning as R¹,
Y is a functional group —NR²₂, —OC(O)C(R)═CH₂ (R═H, C₁-C₁₅-hydrocarbon radical, preferably a C₁-C₈-hydrocarbon radical, particularly preferably a C₁-C₃-hydrocarbon radical, -vinyl, -hydroxyl, -halogen, phosphonato, —NCO, —NH—C(O)—OR (R═C₁-C₁₅-hydrocarbon radical, preferably a C₁-C₈-hydrocarbon radical, particularly preferably a C₁-C₃-hydrocarbon radical), protected isocyanato group —N(H)C(O)-G, characterized in that the protective group G is eliminated as a compound H-G under thermal load, -glycidoxy, —SH, acid anhydrides, such as succinic anhydride,
with the proviso that v is 1, 2 or 3, preferably 1 or 3,
   w+x+y+z=4, it being possible for w, x, y and z to be any, including nonintegral, number <4, u+t=4, it being possible for u and t to be any, including nonintegral, number <4, and u=3g+2f+e and t=g+2f+3e+4d, and furthermore r+q=3, it being possible for r and q to be any, including nonintegral, number <3, and r=2c+b and q=c+2b+3a, and furthermore o+n+m+l=4, it being possible for o, n, m, l to be any, including nonintegral, number <4, and o+n=2, it being possible for o and n to be any, including nonintegral, number ≦2, o is preferably 0 when R¹ is methyl, m=z′ and l=z′+2y′, and furthermore i+j=3, it being possible for i and j to be any, including nonintegral, number ≦3, j are preferably 0 when R¹ is methyl.

The coefficients s, p, k and h are obtainable, for example, from the integral intensities of the Q, T, D and M groups, respectively, of a ²⁹Si-NMR spectrum of the extract of the metal oxides according to the invention or from the integral intensities of T, D and M groups, respectively, of a ²⁹Si-CPMAS-NMR spectrum of the solid metal oxides. The coefficients g (=Q¹), f (=Q²), k (=Q³), h (=Q⁴), c (=T¹), b (=T²), a (=T³), z′ (=D¹) and y′ (=D²) are obtainable, for example, from the integral intensities of the Q¹ to Q⁴, T¹ to T³, D¹ to D² and M groups, respectively, of the ²⁹Si-NMR spectrum of the extract of the metal oxides according to the invention or from the area contents of the abovementioned groups after peak deconvolution by means of a Gaussian or Lorentzian fit of a ²⁹Si-CPMAS-NMR spectrum of the solid metal oxides according to the invention. According to generally customary convention, the abbreviations have the following meaning:

Q=tetrasilyloxy groups with:

Q¹=(Si(OR)₃O_{1/2})

Q²=(Si(OR)₂O_{2/2})

Q³=(Si(OR)O_{3/2})

Q⁴=(SiO_{4/2})

T=trisilyloxy groups with:

T¹=RSi(OR)₂O_{1/2})

T²=RSi(OR)O_{2/2})

T³=RSiO_{3/2})

D=disilyloxy groups with:

D¹=R₂Si(OR²)O_{1/2}) or

D²=R₂SiO_{2/2})

the radical R in the abovementioned formulae generally being alkyl radicals, optionally also substituted alkyl radicals, in order to represent the degree of substitution of the Si atom, and does not constitute a limitation in the context of the patent.

Examples of D groups in the context of this patent are, for example,

D¹=((Y—(CH₂)ᵥ)Si(R¹)(OR²)O_{1/2}) or (R¹)₂Si(OR²)O_{1/2})

D²=((Y—(CH₂)ᵥ)Si(R¹)O_{2/2}) or (R¹)₂SiO_{2/2})

Examples of T groups in the context of this patent are, for example,

T¹=((Y—(CH₂)ᵥ)Si(OR²)₂O_{1/2})

T²=((Y—(CH₂)ᵥ)Si(OR²)O_{2/2})

T³=((Y—(CH₂)ᵥ)SiO_{3/2})

Examples of M groups in the context of this patent are, for example,

M=((Y—(CH₂)ᵥ)Si(R¹)₂O_{1/2}) or (R¹₃SiO_{1/2})

Y, R¹, R², v having the abovementioned meaning.

For modification of the metal oxides, silanes of the general formula (III)

X_{1+x′}—SiR¹_{2-x′}—(CH₂)ᵥ—Y (III),

can be used alone or in any mixtures,
X being halogen, a nitrogen radical, OR², OCOR², O(CH₂)ₕOR², R¹, R², Y, v having the abovementioned meaning and x′ being 1 or 2.

Preferably used silanes of the formula III are silanes in which the radical Y is vinyl, acrylate, methacrylate, glycidyloxy, —SH, —OH, primary amine radical —NH₂, secondary amine radicals —NHR, such as N-monomethyl, N-monoethyl, N-monopropyl, N-monobutyl, N-cyclohexyl, or the anilino radical, tertiary amine radicals —NR₂, such as the N,N-dimethyl, N,N-diethyl, N,N-dipropyl, N,N-dibutyl, N,N-methylethyl, N,N-methylpropyl, N,N-ethylpropyl or N,N-methylphenyl radical or the morpholino radical, the pyrrolyl radical, the indolyl radical, the pyrazoyl, imidazoyl or piperidyl radical, quaternary amine radicals, such as the N,N,N-trimethylammonium, N,N,N-triethylammonium or N,N,N-tripropylammonium radical, in which Y is phosphonato, —P(O)(OR)₂ (R=methyl, ethyl, phenyl), isocyanato and protected isocyanato group —N(H)C(O)G, the protective group G being eliminated as H-G under thermal load (H-G=methyl 2-hydroxybenzoate, 2-hydroxypyridine, 1-hydroxymethyl-1,2,4-triazole, N,N-diethylhydroxylamine, 2-butanone oxime, dimethyl malonate, ethyl acetoacetate, diisopropylamine, benzyl-tert-butylamine, tert-butylmethylamine, tert-butylisopropylamine, 2-isopropylimidazole, 3,5-dimethylpyrazole and ε-caprolactam), or in which Y is dihydro-3-yl-2,5-furandione.

Example of R¹ are preferably: alkyl radicals, such as the methyl radical, ethyl radical, propyl radicals, such as the isopropyl or n-propyl radical, butyl radicals, such as the tert-butyl or n-butyl radical, pentyl radicals, such as the neopentyl radical and the isopentyl or n-pentyl radicals, hexyl radicals, such as the n-hexyl radical, n-heptyl radical, octyl radicals, such as the 2-ethylhexyl or n-octyl radical, decyl radicals, such as the n-decyl, dodecyl radicals, such as the n-dodecyl radical, hexadecyl radicals, such as the n-hexadecyl radical, octadecyl radicals, such as the n-octadecyl radical, aryl radicals such as the phenyl, biphenyl or naphthenyl radical, alkylaryl radicals, such as the benzyl, ethylphenyl, toluyl or the xylyl radicals, preferably methyl radical, ethyl radical or propyl radicals, such as the isopropyl or n-propyl radical and particularly preferably the methyl radical.

For the surface modification, the silanes of the general formula III can be used alone or in any mixtures with organosiloxanes composed of units of the formula

(R¹₃SiO_{1/2}), and/or

(R¹₂SiO_{2/2}), and/or

(R¹SiO_{3/2}),

the number of these units in an organosiloxane being at least 2 and R¹ having the abovementioned meaning and it being possible for the radicals R¹ to be identical or different. The organosiloxanes are preferably liquid at the coating temperature.

Examples of organosiloxanes are linear or cyclic dialkylsiloxanes having an average number of dialkylsilyloxy units of greater then 2, preferably greater than 10.

The dialkylsiloxanes are preferably dimethylsiloxanes.

Examples of linear polydimethylsiloxanes are those having the terminal groups: trimethylsilyloxy, dimethylhydroxysilyloxy, dimethylchlorosilyloxy, methyldichlorosilyloxy, dimethylmethoxysilyloxy, methyldimethoxysilyloxy, dimethylethoxysilyloxy, methyldiethoxysilyloxy, dimethylacetoxysilyloxy, methyldiacetoxysilyloxy; trimethylsilyloxy and dimethylhydroxysilyloxy are preferred.

The terminal groups may be identical or different.

For the surface modification, the silanes of the general formula III can particularly preferably be used alone or in any mixtures with silanes of the general formula IV

Si(X)₄ (IV),

and/or of the general formulae V-a to V-c

R¹₃SiX (V-a),

R¹₂SiX₂ (V-b),

R¹SiX₃ (V-c),

in which X and R¹ have the abovementioned meaning and the radicals R¹ can be identical or different. X are preferably a chloride radical, methoxy radical, ethoxy radical and acetoxy radical. The methoxy and the ethoxy radical are particularly preferred. Preferably, R¹ is a methyl radical, ethyl radical, propyl radical, hexyl radical, octyl radical, such as the n-octyl or isooctyl radical, hexadecyl radical, octadecyl radical, phenyl radical, particularly preferably the methyl radical.

In the process according to the invention, a metal oxide which carries OH groups on the surface and is to be surface-modified is used.

A metal oxide having a mean particle size of less than 1000 μm, in particular having a mean primary particle size of from 5 to 100 nm, is preferably used as a base (starting) material of the surface modification. These primary particles cannot exist in isolation but may be constituents of larger aggregates and agglomerates.

Preferably, the metal oxide has a specific surface area of, preferably, from 0.1 to 1000 m²/g (measured by the BET method according to DIN 66131 and 66132), particularly preferably of from 10 to 500 nm²/g.

The metal oxide may have aggregates (definition according to DIN 53206) in the diameter range of, preferably, from 100 to 1000 nm, the metal oxide having agglomerates (definition according to DIN 53206) which are composed of aggregates and, depending on the external shear load (for example, due to the measuring conditions) can have sizes of from 1 to 1000 μm.

Preferably, the metal oxide has a particle size of less than 1000 nm, preferably from 10 to 750 nm, particularly preferably from 50 to 650 nm and, in a specific embodiment, from 75 to 500 nm, measured by means of photon correlation spectroscopy with 173° back-scattering in aqueous suspension with a proportion of particles of less than 1% by weight and a pH which, according to the prior art, leads to stable colloidal dispersion of the particles, i.e. the zeta potential must be at least ±30 mV.

For reasons relating to technical handling, the metal oxide is preferably an oxide having a covalent bond fraction in the metal-oxygen bond, preferably an oxide in the solid state of aggregation of the main and subgroup elements, such as of the 3rd main group, such as boron, aluminum, gallium or indium oxide, or of the 4th main group, such as silicon dioxide, germanium dioxide or tin oxide or dioxide, lead oxide or dioxide, or an oxide of the 4th subgroup, such as titanium dioxide, zirconium oxide or hafnium oxide. Other examples are stable nickel, cobalt, iron, manganese, chromium or vanadium oxides.

Aluminum(III), titanium(IV) and silicon(IV) oxides are particularly preferred, such as silicic acids, silica sols or silica gels prepared by the wet chemical method and, for example, precipitated, or aluminum oxides, titanium dioxides or silicon dioxides prepared in processes at elevated temperature, such as, for example, preferably pyrogenically prepared aluminum oxides, titanium dioxides or silicon dioxides or silicic acid.

Other solids are silicates, aluminates or titanates, or aluminum phyllosilicates such as bentonites, such as montmorillonites, or smectites or hectorites.

Pyrogenic silicic acid which is prepared in a flame reaction from organosilicon compounds is particularly preferred, for example prepared from silicon tetrachloride or methyldichlorosilane, or hydrogen trichlorosilane or hydrogen methyldichlorosilane or other methylchlorosilanes or alkylchlorosilanes, also as a mixture with hydrocarbons, or any volatilizable or sprayable mixtures of organosilicon compounds, as mentioned, and hydrocarbons, for example in a hydrogen-oxygen flame, or a carbon monoxide-oxygen flame. The preparation of the silicic acid can optionally be effected with and without additional addition of water, for example in the purification step; preferably no water is added.

Any mixtures of said metal oxides can be used for the surface modification.

The pyrogenic silicic acid preferably has a fractal dimension of the surface of preferably less than or equal to 2.3, particularly preferably less than or equal to 2.1, especially preferably from 1.95 to 2.05, the fractal dimension of the surface Dₛ being defined here as:

particle surface area A is proportional to the particle radius R to the power of Dₛ.

The silicic acid preferably has a fractal dimension of the mass Dₘ of preferably less than or equal to 2.8, preferably less than or equal to 2.7, particularly preferably from 2.4 to 2.6. The fractal dimension of the mass Dₘ is defined here as:

particle mass M is proportional to the particle radius R to the power of Dₘ.

Preferably, the silicic acid has a density of accessible surface silanol groups SiOH, i.e. surface silanol groups accessible to chemical reaction, of less than 2.5 SiOH/nm², preferably less than 2.1 SiOH/nm², preferably less than 2 SiOH/nm², particularly preferably from 1.7 to 1.9 SiOH/nm².

Silicic acids prepared by a wet chemically prepared method or at elevated temperature (greater than 1000° C.) can be used. Pyrogenically prepared silicic acids are particularly preferred. It is also possible to use hydrophilic metal oxides which are obtained in freshly prepared form directly from the burner, temporarily stored or already packed in commercially available form. It is also possible to use water-repellent metal oxides or silicic acids, e.g. commercially available silicic acids.

Uncompacted metal oxides or silicic acids having bulk densities of preferably less than 60 g/l, but also compacted metal oxides or silicic acids having bulk densities of, preferably, greater than 60 g/l can be used.

Mixtures of different metal oxides or silicic acids can be used, for example mixtures of metal oxides or silicic acids of different BET surface area, or mixtures of metal oxides having different degrees of water repellency or silylation.

In a preferred process, the dry pulverulent metal oxide is reacted directly with the very finely divided silanes of the general formula II—optionally as a mixture with other silanes or siloxanes of the general formula II, III, IV or V-a-V-c.

The process can be carried out continuously or batchwise and may be composed of one or more steps. Preferably, the modified metal oxide is prepared by means of a process in which the preparation process is effected in separate steps: (A) first preparation of the hydrophilic metal oxide, (B) modification of the hydrophilic metal oxide with (1) loading of the hydrophilic metal oxide with the silane, (2) reaction of the metal oxide with the applied compounds and (3) purification of the metal oxide to remove compounds applied in excess and cleavage products.

The surface treatment is preferably carried out in an atmosphere comprising less than 10% by volume of oxygen, particularly preferably less than 2.5% by volume; best results are obtained with less than 1% by volume of oxygen.

Coating, reaction and purification can be carried out as a batchwise or continuous process, the continuous process being preferred.

The coating (step B1) is effected at temperatures of from —30° C. to 250° C., preferably at temperatures of from 20° C. to 150° C., particularly preferably at temperatures of from 20° C. to 100° C.; in a specific embodiment, the coating step is effected at from 30° C. to 50° C.

The residence time is from 1 min to 24 h, preferably from 15 min to 240 min, for reasons relating to the space-time yield particularly preferably from 15 min to 90 min.

The pressure during the coating ranges from slightly reduced pressure to 0.2 bar and up to a gage pressure of 100 bar, for technical reasons normal pressure, i.e. working at external/atmospheric pressure without applied pressure, being preferred.

The silanes or mixtures thereof are preferably fed in liquid form and in particular mixed with the pulverulent metal oxide. The compounds can be admixed in pure form or as solutions in known industrially used solvents, such as, for example, alcohols, such as, for example, methanol, ethanol or isopropanol, ethers, such as, for example, diethyl ether, THF or dioxane, or hydrocarbons, such as, for example, hexanes or toluene. The concentration in the solution is 5-95% by weight, preferably 30-95% by weight, particularly preferably 50-95% by weight.

The admixing is preferably effected by nozzle techniques or comparable techniques, such as effective spraying techniques, such as spraying in 1-material nozzles under pressure (preferably at from 5 to 20 bar), spraying in 2-material nozzles under pressure (preferably gas and liquid, 2-20 bar), very fine distribution using atomizers or gas-solid exchange units with movable, rotating or static internals which permit homogeneous distribution of the silanes or mixtures thereof with the pulverulent metal oxide. Preferably, the silanes or mixtures thereof are fed in as very finely divided aerosol, the aerosol having a settling rate of 0.1-20 cm/s.

Loading of the metal oxide and the reaction with the silanes are preferably effected with mechanical or gas-borne fluidization. The mechanical fluidization is particularly preferred. A gas-borne fluidization can be effected by all inert gases, such as, preferably, N₂, Ar, other noble gases, CO₂, etc.

The gases for fluidization are preferably fed in the range of superficial gas velocities of from 0.05 to 5 cm/s, particularly preferably from 0.5 to 2.5 cm/s.

Mechanical fluidization which is effected without additional use of gas over and above the blanketing, by paddle stirrers, anchor stirrers and other suitable stirring members, is particularly preferred.

The reaction is preferably effected at temperatures of 20-300° C., preferably 20-200° C. and particularly preferably at 40-180° C.

The reaction was preferably effected in a temperature gradient, i.e. the reaction temperature increases in the course of the reaction time.

This means that the wall temperature of the reaction container is in a range of 20-180° C., preferably in a range of 40-120° C., at the beginning of the reaction and the wall temperature of the reaction container is in a range of 120-300° C., preferably in a range of 120-200° C., toward the end of the reaction, with the proviso that the wall temperature of the reaction container at the beginning of the reaction is lower than toward the end of the reaction. Preferably, the wall temperature of the reaction container is therefore in a range of 20-180° C. at the beginning of the reaction and in a range of 120-300° C. toward the end of the reaction, with the proviso that the wall temperature of the reaction container is lower at the beginning of the reaction than toward the end of the reaction, the wall temperature of the reaction container is preferably in a range of 40-120° C. at the beginning of the reaction and in a range of 120-200° C. toward the end of the reaction.

This furthermore means that the product temperature is in a range of 20-180° C., preferably in a range of 40-120° C., at the beginning of the reaction and the product temperature is in a range of 120-300° C., preferably in a range of 120-200° C., toward the end of the reaction, with the proviso that the product temperature is lower at the beginning of the reaction than toward the end of the reaction. Preferably, the product temperature is therefore in a range of 20-180° C. at the beginning of the reaction and in a range of 120-300° C. toward the end of the reaction, with the proviso that the product temperature is lower at the beginning of the reaction than toward the end of the reaction, preferably the product temperature is in a range of 40-120° C. at the beginning of the reaction and in a range of 120-200° C. toward the end of the reaction. This means, that depending on the manner in which the process is carried out, i.e. continuous or batchwise process, the temperature gradient may be dependent on the location dT/dx (continuous) or dependent on the time dT/dt (batchwise); the continuous process is preferred.

The reaction temperature, i.e. the wall or product temperature, and the gradient thereof can be achieved according to the following process.

1. Continuous course of process (i.e. dT/dx):

The metal oxide is transported by means of gas-borne or mechanical fluidization/transport through a heating zone with increasing wall temperature. The wall temperature may increase continuously or in steps. In the case of a stepwise increase, the reaction zone may consist of up to 10 separate heating zones of different temperature, preferably 5 separate heating zones of different temperature, particularly preferably 3 separate heating zones of different temperature, in a specific embodiment of 2 separate heating zones of different temperature, i.e. of temperature increasing from heating zone to heating zone. Optionally, the individual heating zones can be separated from one another by flaps. The reaction container may be vertical or horizontal. The vertical embodiment is preferred. In the case with vertical embodiment, the metal oxide can pass through the reaction zone from bottom to top or from top to bottom. From top to bottom is preferred.

Alternatively:

The metal oxide is transported by means of gas-borne or mechanical fluidization/transport through separate reaction containers having different, i.e. increasing wall temperature. The reaction cascade may consist of up to 10 reaction containers of different wall temperature, preferably up to 5 reaction containers of different wall temperature, particularly preferably up to 3 reaction containers of different wall temperature, and in a specific embodiment of 2 reaction containers of different wall temperature, with the proviso that the wall temperature increases from reaction container to reaction container. The reaction containers may be vertical or horizontal. The vertical embodiment is preferred. In the case of a vertical embodiment, the metal oxide can pass through the reaction zone from bottom to top or from top to bottom. From top to bottom is preferred.

Alternatively:

The metal oxide is transported by means of mechanical fluidization/transport through a vertical reaction container. The reaction container is heated in the lower part to the maximum reaction temperature. A temperature gradient between the upper part of the reaction container (lowest temperature) and the lower part of the reaction container (highest temperature) is then established in the reaction container. The temperature gradient of the product temperature can be controlled, for example, by suitable stirring technology with plug flow. This can preferably be achieved by a combination of different stirring elements which may be arranged in segments. Thus, for example, segments with horizontal mixing followed by segments with vertical mixing characteristic can be used.

2. Batchwise course of production (batch operation)

The metal oxide is fluidized in the reaction container by means of inert gas or mechanical stirring. In the course of the duration of reaction, the reaction temperature is increased gradually in the reaction container, i.e. in the form of a ramp or stepwise.

The residence time per reaction temperature is from 5 min to 240 min, preferably from 10 min to 180 min and particularly preferably from 15 min to 120 min.

The heating of the reaction zone can be effected, for example, via the container wall, for example by means of electrical heating or by means of thermostating liquid or vapor. For example, heating coils can optionally be used in the reaction vessel.

The heating can optionally be effected from outside via infrared radiators.

The temperature measurement of wall and product temperature can be effected by means of measuring instruments usually used, such as thermocouples, resistance thermometers, bimetal thermometers, IR sensors, etc.

The total reaction time is from 10 min to 48 h, preferably from 15 min to 5 h, particularly preferably from 20 min to 4 h.

For the surface modification, water is preferably added in addition to the abovementioned silanes. The minimum amount of water to be added is n(H₂O)=n(hydrol)/2−n(MOH), where n(hydrol) is the amount of hydrolyzable groups, such as alkoxy groups or halo groups, which is fed in with the abovementioned silanes, and n(MOH) is the total amount of OH groups of the hydrophilic starting metal oxide used. The maximum amount of water to be added is given by n(H₂O)=f·n(hydrol), where the factor f is not more than 10, preferably from 1 to 5, particularly preferably from 1 to 2.5 and in a specific embodiment from 1 to 1.5. Preferably, the water is added, preferably sprayed in, separately from the abovementioned silanes, i.e. separate nozzles are used for water and silane.

Optionally, further protic solvents may be added, such as liquid or vaporizable alcohols; typical alcohols are isopropanol, ethanol and methanol. Mixtures of the abovementioned protic solvents may also be added.

Optionally, acidic catalysts, of acidic character in the sense of a Lewis acid or of a Brönsted acid, such as hydrogen chloride or acetic acid, or basic catalysts, of basic character in the sense of a Lewis base or of a Brönsted base, such as ammonia or amines, such as triethylamine, may be added. These are preferably added in traces, i.e. less than 1%.

The purification is preferably effected at a purification temperature of from 20° C. to 200° C., preferably at from 50° C. to 180° C., particularly preferably at from 50° C. to 150° C.

The purification step is preferably characterized by movement, slow movement and slight mixing being particularly preferred. The stirring members are advantageously adjusted and moved so that preferably mixing and fluidization but not complete turbulence, occurs.

The purification step can furthermore be characterized by increased introduction of gas, corresponding to a superficial gas velocity of, preferably, from 0.001 to 10 cm/s, preferably from 0.01 to 1 cm/s. This can be effected by all inert gases, such as, preferably, N₂, Ar, other noble gases, CO₂, etc.

In addition, methods for mechanical compaction of the metal oxide can be used during the modification or after the purification, such as, for example, pressure rollers, milling units, such as edge mills and such as ball mills, continuously or batchwise, compaction by screws or screw mixers, screw compactors, briquetting apparatuses, or compaction by removal of the air or gas content by suction by suitable vacuum methods.

Mechanical compaction during the modification, in step B2 of the reaction by means of pressure rollers, abovementioned milling units, such as ball mills, or compaction by screws, screw mixers, screw compactors, briquetting apparatuses, is particularly preferred.

In a further particularly preferred procedure, methods for mechanical compaction of the metal oxide are used after the purification, such as compaction by removal of the air or gas content by suction by suitable vacuum methods or pressure rollers or combinations of the two methods.

In a particularly preferred procedure, methods for deagglomeration of the metal oxide, such as pinned-disk mills, hammer mills, countercurrent mills, impact mills or apparatuses for milling and classification, can additionally be used after the purification.

In a further preferred process, dispersions of the hydrophilic metal oxide in water or typical industrially used solvents, such as alcohols, such as methanol, ethanol, isopropanol, such as ketones, such as acetone, methyl ethyl ketone, such as ethers, such as diethyl ether, THF, hydrocarbons, such as pentane, hexanes, aromatics, such as toluene, or other volatile solvents, such as hexamethyldisiloxane, or mixtures thereof, are reacted with silanes of the general formula II.

The process can be carried out continuously or batchwise and may be composed of one or more steps. A continuous process is preferred. The modified metal oxide is preferably prepared by means of a process in which the metal oxide (1) is mixed in in one of the abovementioned solvents, (2) is reacted with the silanes and (3) is freed from solvents, excess silanes and byproducts.

The dispersing (1), reaction (2), drying (3) and optionally postreaction (4) are preferably carried out in an atmosphere comprising less than 10% by volume of oxygen, particularly preferably less than 2.5% by volume; best results are achieved in the case of less than 1% by volume of oxygen.

The mixing in (1) can be effected by means of customary mixing units, such as anchor stirrers or straight-arm paddle agitators. The mixing in can optionally be effected with high shearing by means of dissolvers, rotor-stator units, optionally with direct metering into the shear gap, by means of ultrasound generators or by means of milling units, such as ball mills. Different units from among the abovementioned units can optionally be used in parallel or in succession.

For the reaction (2) of the silanes of the general formula II with the metal oxide, the silanes are added in pure form or as a solution in suitable solvents to the metal oxide dispersion and homogeneously mixed. The addition of the silanes can be effected in the container which is used for the preparation of the dispersion or in a separate reaction container. If the silanes are fed in in the dispersing container, this can be effected simultaneously with or after the end of the dispersing. Optionally, the silanes dissolved in the dispersing medium can be fed in directly in the dispersing step.

Preferably, water is added to the reaction mixture, in addition to abovementioned silanes. The minimum amount of water to be added is n(H₂O)=n(hydrol)/2−n(MOH), where n(hydrol) is the amount of hydrolyzable groups, such as alkoxy groups or halo groups, which is fed in with the abovementioned silanes and n(MOH) is the total amount of OH groups of the hydrophilic starting metal oxide used. The maximum amount of water to be added is given by n(H₂O)=f·n(hydrol), where the factor f is not more than 10, preferably from 1 to 5, particularly preferably from 1 to 2.5 and, in a specific embodiment, from 1 to 1.5.

Acidic catalysts, such as Brönsted acids, such as liquid or gaseous HCl, sulfuric acid, phosphoric acid or acetic acid, or basic catalysts, such as Brönsted bases, such as volatile or gaseous ammonia, amines, such as NEt₃ or NaOH, are optionally added to the reaction mixture.

The reaction step is carried out at a temperature of from 0° C. to 200° C., preferably at from 10° C. to 180° C. and particularly preferably from 20° C. to 150° C.

The removal of solvents, excess silanes and byproducts (3) can be effected by means of drying or by spray-drying.

A postreaction step (4) for completing the reaction can optionally also follow the drying step.

The postreaction is preferably effected at temperatures of 20-300° C., preferably 20-200° C. and particularly preferably at 40-180° C.

The postreaction was preferably effected in a temperature gradient, i.e. the reaction temperature increases in the course of the reaction time, as already described above for the case of the modification of the metal oxide as a solid.

The total postreaction time is from 10 min to 48 h, preferably from 15 min to 5 h, particularly preferably from 20 min to 4 h.

In addition, methods for mechanical compaction of the metal oxide can be used after drying or postreaction, such as, for example, pressure rollers, milling units, such as edge mills and such as ball mills, continuously or batchwise, compaction by screws or screw mixers, screw compactors, briquetting apparatuses, or compaction by removal of the air or gas content by suction by suitable vacuum methods.

In a further particularly preferred procedure, methods for the mechanical compaction of the metal oxide are used after the drying or postreaction, such as compaction by removal of the air or gas content by suction by suitable vacuum methods or pressure rollers or a combination of the two methods.

In a particularly preferred procedure, methods for deagglomerating the metal oxide, such as pinned-disk mills, hammer mills, countercurrent mills, impact mills or apparatuses for milling and classification, may additionally be used after the drying or postreaction. The modified metal oxide particles according to the invention have particularly little influence on the viscosity and viscoelastic properties of a liquid if the surface-modifying layer has the structure of an organosilicon resin according to the general equation I

(Y—(CH₂)ᵥ)_{w}Si(R¹)ₓ(OR²)_{y}O_{z/2} (I),

or the general equation II

(Si(OR²)ᵤO_{t/2})ₛ((Y—(CH₂)ᵥ)Si(OR²)ᵣO_{q/2})ₚ((Y—(CH₂)ᵥ)ₒSo(R¹)ₙ(OR²)ₘO_{1/2})ₖ((Y—(CH₂)ᵥ)ⱼSi(R¹)ᵢO_{1/2})ₕ (II),

and furthermore is chemically fixed, i.e. cannot be detached by the surrounding medium, and is of sufficient thickness.

The relative composition of the organofunctional silicone resin layer, i.e. the ratio of Q groups:T groups:D groups:M groups, i.e. the ratio of the coefficients s:p:k:h in equation II, can be determined, for example, by means of 29Si-NMR spectroscopy from the extractable fraction of the silicone resin layer. The area fraction F of the individual peaks is determined from the integral intensities of the individual signals for the Q, T, D and M groups relative to the sum of the intensities, i.e.

F(Q)=s=I(Q)/I(Q)+I(T)+I(D)+I(M)

F(T)=p=I(T)/I(Q)+I(T)+I(D)+I(M)

F(D)=k=I(D)/I(Q)+I(T)+I(D)+I(M)

F(M)=h=I(M)/I(Q)+I(T)+I(D)+I(M)

In the case of Q group-free silicone resin layers, i.e. s=0, the ratio T groups:D groups:M groups, i.e. the ratio of the coefficients p:k:h in equation II, can be determined more easily by solid-state NMR spectroscopy in the ²⁹Si-CPMAS mode. The area fraction F of the individual peaks is determined from the integral intensities of the individual signals for the T, D and M groups relative to the sum of the intensities, i.e.

F(T)=p=I(T)/I(T)+I(D)+I(M)

F(D)=k=I(D)/I(T)+I(D)+I(M)

F(M)=h=I(M)/I(T)+I(D)+I(M)

I being the signal intensity (=integral value) of the corresponding peak.

The coefficients g, f, e and d, i.e. the relative proportion of the Q1, Q2, Q3 and Q4 groups, the coefficients c, b and a, i.e. the relative proportion of the T1, T2 and T3 groups and the coefficients z′ and y′, i.e. the relative proportion of the D1 and D2 groups and the relative proportion of the M groups, can be determined, for example, by means of 29Si-NMR spectroscopy from the extractable fraction of the silicone resin layer. The relative area fraction F of the individual peaks is determined from the integral intensities of the corresponding individual signals for the Q¹, Q², Q³, Q⁴ groups or T¹, T², T³ groups or D¹ and D² groups and M groups relative to the sum of the intensities of the Q groups or T groups or D groups or M groups, respectively, i.e.

F(Q¹)=g=I(Q¹)/I(Q¹)+I(Q²)+I(Q³)+I(Q⁴)

An analogous procedure is adopted for the other abovementioned groups.

In the case of Q group-free silicone resin layers, i.e. s=0, the ratio of the coefficients c, b and a, i.e. the relative proportion of the T¹, T² and T³ groups, and the coefficients z′ and y′, i.e. the relative proportion of the D¹ and D² groups, and the relative proportion of the M groups can be more easily determined by solid-state NMR spectroscopy in the ²⁹Si-CPMAS mode. The relative area fraction F of the individual peaks is determined from the individual peak areas (PA) of the corresponding individual signals for the Q¹, Q², Q³, Q⁴ groups or T¹, T², T³ groups or D¹ and D² groups and M groups relative to the total peak area of the Q groups or T groups or D groups or M groups, respectively, i.e.

F(T¹)=c=PA(T¹)/PA(T¹)+PA(T²)+PA(T³),

the individual peak areas (PA) being obtainable by peak deconvolution of the total peak of the corresponding group signal by means of a Gaussian fit.

An analogous procedure is adopted for the other abovementioned groups.

The chemical shift of the individual organosilicon groups in the ²⁹Si-NMR spectrum is given, for example, in D. W. Sindorf, G. E. Maciel, Journal of the American Chemical Society 1983, 105, 3767.

The metal oxides according to the invention are distinguished by a defined organofunctional silicone resin structure, i.e. a defined ratio of Q, T, D and M groups. For the metal oxides according to the invention, the ratio of Q groups:T groups:D groups:M groups is 0 to 0.50:0 to 1.0:0 to 0.1:0 to 0.25, preferably 0 to 0.30:0 to 1.0:0 to 1.0:0 to 0.15. Preferably, the ratio of the D¹ groups to D² groups is 0 to 0.9:0.1 to 1.0, preferably 0 to 0.8:0.20 to 1.0, and the ratio of the T¹ groups, T² groups, T³ groups is characterized in that the sum of the intensities of the T² and T³ groups is at least factor 3, preferably at least a factor 4, greater than the intensity of the T¹ groups. Preferably, the ratio of the T¹ groups:T² groups:T³ groups is 0.01 to 0.20:0.05 to 0.9:0.05 to 0.9, preferably 0.025 to 0.2:0.10 to 0.85:0.10 to 0.85, particularly preferably 0.025 to 0.15:0.2 to 0.75:0.2 to 0.75, preferably with the proviso that detectable amounts of each type of the T groups are present in the organofunctional silicone resin layer of the metal oxides according to the invention.

In a preferred embodiment, the organofunctional silicone resin structure consists of Q groups and D groups. The ratio of Q groups to D groups is 0.05 to 0.5:0.5 to 0.95, preferably 0.1 to 0.3:0.7 to 0.9 and particularly preferably 0.15 to 0.25:0.75 to 0.85, the ratio of the D¹ groups to D² groups preferably being 0 to 0.9:0.1 to 1.0, preferably 0 to 0.8:0.20 to 1.0.

In a further preferred embodiment, the organofunctional silicone resin structure consists of T groups and D groups. The ratio of T groups to D groups is 0.05 to 0.95:0.05 to 0.95, preferably 0.5 to 0.95:0.05 to 0.5, the ratio of the D¹ groups to D² groups preferably being 0 to 0.9:0.1 to 1.0, preferably 0 to 0.8:0.20 to 1.0, and the ratio of the T¹ groups:T² groups:T³ groups being characterized in that the sum of the intensities of the T² and T³ groups is at least a factor 3, preferably at least a factor 4, greater than the intensity of the T¹ groups. Preferably, the ratio of the T¹ groups:T² groups:T³ groups is 0.01 to 0.20:0.05 to 0.9:0.05 to 0.9, preferably 0.025 to 0.2:0.10 to 0.85:0.10 to 0.85, particularly preferably 0.025 to 0.15:0.2 to 0.75:0.2 to 0.75, preferably with the proviso that detectable amounts of each type of the T groups are present in the organofunctional silicone resin layer of the metal oxides according to the invention.

In a further preferred embodiment, the organofunctional silicone resin structure consists of T groups, the ratio of the T¹ groups:T² groups:T³ groups being characterized in that the sum of the intensities of the T² and T³ groups is at least a factor 3, preferably at least a factor 4, greater than the intensity of the T¹ groups. Preferably, the ratio of the T¹ groups:T² groups:T³ groups is 0.01 to 0.20:0.05 to 0.9:0.05 to 0.9, preferably 0.025 to 0.2:0.10 to 0.85:0.10 to 0.85, particularly preferably 0.025 to 0.15:0.2 to 0.75:0.2 to 0.75, preferably with the proviso that detectable amounts of each type of the T groups are present in the organofunctional silicone resin layer of the metal oxides according to the invention.

The metal oxides according to the invention furthermore have an average surface layer thickness L of the organofunctional silicone resin layer of greater than 0.9 nm, preferably from 0.8 to 20 nm, particularly preferably from 1 to 10 nm and, in a specific embodiment, from 1 to 5 nm.

The average surface layer thickness L of the organofunctional silicone resin layer can be determined according to the following formula:

$$L = \frac{{m}_{layer}}{{m}_{silica} \cdot {ρ}_{layer} \cdot {S}_{oxide}}$$

There, the meanings are as follows:
m_{layer}: mass of the resin layer per 1 kg of metal oxide; obtainable according to

$${m}_{layer} = {\sum }_{i} {n}_{i} {M}_{i} - \frac{{m}_{extr} \cdot ( 100 + {\sum }_{i} {n}_{i {M}_{i}} )}{100} ;$$

where
nᵢ: molar amount of the i-th component
Mᵢ: molar mass of the i-th component assuming the following general formulae:

Q units as SiO_{4/2}

D units as R₂SiO_{2/2}

T units as RSiO_{3/2}
mₑₓₜᵣ: mass of the extractable fractions of the silicone resin layer according to a process as given in DE 4419234
m_{oxide}: mass of a metal oxide primary particle; obtainable according to

$${m}_{oxide} = \frac{4}{3} {r}_{BET}^{3} π \cdot {ρ}_{oxide} ;$$

where
r_{BET}: primary particle radius determinable from the specific BET surface area SBET according to SBET=3/(r_{BET}*ρ_{oxide})
ρ_{oxide}: density of the metal oxide, e.g. 2200 kg/m3 for SiO₂
ρ_{layer}: specific density of the silicone resin layer; obtainable according to

$${ρ}_{layer} = {\sum }_{i} \frac{{n}_{i} {M}_{i }}{{\sum }_{i} {n}_{i} {M}_{i}} {ρ}_{i } ;$$

where
ρᵢ: specific density of the i-th component with:

1000 kg/m³ for R₂SiO_{2/2}

1300 kg/m³ for RSiO_{3/2}

2200 kg/m³ for SiO_{4/2}
and S_{oxide} is the specific BET surface area of the hydrophilic starting metal oxide.

The metal oxides according to the invention furthermore have a carbon content of greater than 1.0% by weight, preferably from 1.5 to 8% by weight and particularly preferably from 2 to 6.5% by weight, based in each case on a 100 m²/g specific surface area, i.e. correspondingly linearly lower or higher values are obtained in the case of a lower or higher specific surface area.

The metal oxides according to the invention have a content of extractable components of less than 20% by weight, preferably less than 18% by weight and particularly preferably less than 15% by weight.

The metal oxides according to the invention are distinguished in particular in that they have a particularly small thickening effect on liquid media. This means specifically that dispersions containing 15% by mass of the metal oxides according to the invention have a relative viscosity ηᵣ of less than 100, preferably less than 50, particularly preferably less than 25 and, in a specific embodiment, less than 15, the relative viscosity being defined as the quotient ηᵣ=η/η₀ of the shear viscosity of the particle-containing dispersion η divided by the shear viscosity of the particle-free liquid phase η₀ at the same shear rate, the shear viscosity being measured in each case at 25° C. by means of a cone-plate system.

For evaluating the thickening effect of the metal oxides according to the invention, for example liquid, polar or semipolar, crosslinkable monomers, oligomers or polymers or solutions thereof in suitable organic solvents with approximately Newtonian flow behavior can be used. Preferably, the test liquid contains the same functional groups in significant amounts as the organofunctional silicone resin layer of the metal oxide particles.

Furthermore, the metal oxide particles according to the invention are distinguished in that they induce no viscoelastic solid-state behavior in abovementioned liquid media, i.e. that, in a dynamic deformation experiment in the shear stress range from 0.5 to 1000 Pa at a constant angle of velocity of 10 rad/s, the loss factor tan δ=G″/G′ is greater than 1, preferably greater than 5 and very particularly preferably greater than 10, measured at 25° C. by means of a cone-plate system.

The metal oxide particles according to the invention can be used for the preparation of coating materials, preferably for scratch-resistant coating materials and those coating materials having improved surface mechanical properties, for the preparation of adhesives and sealants, preferably for high-strength and impact-resistant adhesives and sealants.

The metal oxide particles according to the invention can be used for improving the mechanical properties of composites based on, for example, epoxides, unsaturated polyesters, etc.

The metal oxide particles according to the invention can be used for the preparation of coating materials, adhesives and sealants having a high load of particulate metal oxide particles in combination with low viscosity and hence excellent processability.

The metal oxide particles according to the invention can be used for the preparation of peroxidically crosslinked or addition-crosslinked silicone rubbers having a high filler content and excellent processing properties, such as flowability of the uncrosslinked materials.

The metal oxide particles according to the invention can be used for the production of high-strength and resilient coatings, adhesives and sealants based on epoxide, with the use of epoxides as binders and use of curing agents, such as, for example, amines, Jeffamines, acid anhydrides, etc.

The metal oxide particles according to the invention can be used for the production of very hard and resilient surface coatings from 2-component POLYURETHANES, with the use of polyols as binders and isocyanates as curing agents, surface coatings having high gloss, low surface abrasion and high transparency being achieved with simultaneous excellent scratch resistance with losses of gloss of less than 50% and high chemical stability.

### EXAMPLES

### EXAMPLE 1

A solution of 15.0 g of water and 0.5 g of NEt₃ and then 66 g of methacrylatopropyltrimethoxysilane are added at a temperature of 25° C. under inert gas N₂ to 100 g of hydrophilic, pyrogenic silicic acid having a specific surface area of 300 m²/g (measured by the BET method according to DIN 66131 and 66132) (obtainable under the name HDK® T30 from Wacker Chemie AG, Munich, Germany), by spraying via a two-material nozzle (pressure 5 bar). The silicic acid loaded in this manner is then reacted, with a total residence time of 3 hours, for 1 hour at 100° C. and then 2 hours at 150° C. in a 100 l drying oven under N₂.

The analytical data are shown in Table 1.

### EXAMPLE 2

In a continuous apparatus, 80 g/h of a solution of 75 parts of water and 5 parts of NEt₃ and 330 g/h of methacrylatopropyltrimethoxysilane in liquid, very finely divided form are fed at a temperature of 30° C. under inert gas N₂ to a mass stream of 1000 g/h of hydrophilic, pyrogenic silicic acid having a specific surface area of 150 m²/g (measured by the BET method according to DIN 66131 and 66132) (obtainable under the name HDK® V15 from Wacker Chemie AG, Munich, Germany), via two-material nozzles (pressure 5 bar). The silicic acid loaded in this manner is reacted, with a total residence time of 3 hours, for 1 h in a reaction container at 100° C. and then in a further reaction container for 2 h at a temperature of 150° C. and fluidized thereby by means of stirring, and then purified in a dryer at 150° C. and with a residence time of 1 hour.

The analytical data are shown in Table 1.

### EXAMPLE 3

800 ml of hexamethyldisiloxane are initially introduced into a 2 l three-necked flask under argon as inert gas and then 50 g of a hydrophilic, pyrogenic silicic acid having a specific surface area of 300 m²/g (measured by the BET method according to DIN 66131 and 66132) (obtainable under the name HDK® T30 from Wacker Chemie AG, Munich, Germany), 34 g of methacrylatopropyltrimethoxysilane, 7.5 g of water and 1.0 g of glacial acetic acid are added. The suspension is heated for 2 h under reflux and, after cooling to room temperature, the solvent is removed by distillation at reduced pressure. Thereafter, the pulverulent residue is reacted, with a total residence time of 3 hours, for 1 h at 100° C. and then 2 h at 150° C. in a 100 l drying oven under N₂.

The analytical data are shown in Table 1.

### EXAMPLE 4

800 ml of hexamethyldisiloxane are initially introduced into a 2 l three-necked flask under argon as inert gas and then 50 g of a hydrophilic, pyrogenic silicic acid having a specific surface area of 300 m²/g (measured by the BET method according to DIN 66131 and 66132) (obtainable under the name HDK® T30 from Wacker Chemie AG, Munich, Germany), 34 g of methacrylatopropyltrimethoxysilane, 11 g of dimethyldimethoxysilane, 9.4 g of tetraethoxysilane, 15 g of water and 1.0 g of glacial acetic acid are added. The suspension is heated for 2 h under reflux and, after cooling to room temperature, the solvent is removed by distillation at reduced pressure. Thereafter, the pulverulent residue is reacted, with a total residence time of 3 hours, for 1 h at 100° C. and then 2 h at 150° C. in a 100 l drying oven under N₂.

The analytical data are shown in Table 1.

### EXAMPLE 5

800 ml of hexamethyldisiloxane are initially introduced into a 2 l three-necked flask under argon as inert gas and then 50 g of a hydrophilic, pyrogenic silicic acid having a specific surface area of 300 m²/g (measured by the BET method according to DIN 66131 and 66132) (obtainable under the name HDK® T30 from Wacker Chemie AG, Munich, Germany), 32 g of glycidyloxypropyltrimethoxysilane, 7.5 g of water and 0.5 g of NEt₃ are added. The suspension is heated for 2 h under reflux and, after cooling to room temperature, the solvent is removed at reduced pressure. Thereafter, the pulverulent residue is reacted, with a total residence time of 3 hours, for 1 h at 100° C. and then 2 h at 150° C. in a 100 l drying oven under N₂.

The analytical data are shown in Table 1.

### EXAMPLE 6

A mixture of 0.5 g of NEt₃ and 66 g of methacrylatopropyltrimethoxysilane are added at a temperature of 25° C. under inert gas N₂ to 100 g of hydrophilic, pyrogenic silicic acid having a specific surface area of 300 m²/g (measured by the BET method according to DIN 66131 and 66132) (obtainable under the name HDK® T30 from Wacker Chemie AG, Munich, Germany), by spraying via a two-material nozzle (pressure 5 bar). The silicic acid loaded in this manner is then reacted for 3 h at 150° C. in a 100 l drying oven under N₂.

The analytical data are shown in Table 1.

### EXAMPLE 7

800 ml of hexamethyldisiloxane are initially introduced into a 2 l three-necked flask under argon as inert gas and then 50 g of a hydrophilic, pyrogenic silicic acid having a specific surface area of 300 m²/g (measured by the BET method according to DIN 66131 and 66132) (obtainable under the name HDK® T30 from Wacker Chemie AG, Munich, Germany), 32 g of glycidyloxypropyltrimethoxysilane and 0.5 g of NEt₃ are added. The suspension is heated for 2 h under reflux and, after cooling to room temperature, the solvent is removed at reduced pressure. Thereafter, the pulverulent residue is reacted for 3 hours at 150° C. in a 100 l drying oven under N₂.

The analytical data are shown in Table 1.

TABLE 1

| | | | Layer | | | |
|---|---|---|---|---|---|---|
| | | Extractable | thickness | Resin composition by | | Empirical formula of resin |
| Example | % C | fraction | [nm] | means of NMR* | ηᵣ | layer |
| 1 | 16.1 | 5.9% | 1.3 | 0.12 T¹:0.45 T²:0.43 T³ | 10 | (C₇H₁₁O₂)Si(OH)_{0.69}O_{2.31/2} |
| 2 | 7.8 | 2.1% | 1.0 | 0.09 T¹:0.48 T²:0.43 T³ | 6 | (C₇H₁₁O₂)Si(OH)_{0.66}O_{2.34/2} |
| 3 | 14.7 | 8.8% | 1.0 | 0.10 T¹:0.61 T²:0.29 T³ | 9 | (C₇H₁₁O₂)Si(OH)_{0.81}O_{2.19/2} |
| 4 | 15.3 | 8.0% | 1.3 | 0.10 D¹:0.21 D²:0.02 | 7 | (C₇H₁₁O₂)_{0.55}Si(CH₃)_{0.62}(OH)_{0.69}O_{2.31/2} |
| | | | | T¹:0.25 T²:0.28 | | |
| | | | | T³:0.14 Q | | |
| 5 | 12.7 | 0.2% | 1.1 | 0.08 T¹:0.59 T²:0.33 T³ | 2** | (C₆H₁₁O₂)Si(OH)_{0.75}O_{2.25/2} |
| 6 | 17.2 | 25.1% | 0.8 | 0.45 T¹:0.34 T²:0.21 T³ | 630 | (C₇H₁₁O₂)Si(OCH₃)_{1.24}O_{1.76/2} |
| 7 | 15.1 | 19.5% | 0.8 | 0.34 T¹:0.41 T²:0.26 T³ | n.d. | (C₆H₁₁O₂)Si(OCH₃)_{1.09}O_{1.91/2} |

*Measured in the CPMAS mode; Example 4 was measured in solution. In Examples 6 and 7, the intensities were standardized to the total intensity T¹ + T² + T³, i.e. any T⁰ groups present were not taken into account.
**Dispersion in a bisphenol A epoxy resin having a viscosity of 8 Pas. Dispersed using a dissolver to a constant grindometer value.

Description of the Analytical Methods

1. Carbon content (%C)
Elemental analysis for carbon; combustion of the sample at above 1000° C. in an O₂ stream, detection and quantification of the resulting CO₂ by IR; LECO 244 apparatus.

2. Extractable silylating agent
25 g of silicic acid are incorporated into 100 g of THF by means of a spatula and then stirred to liquid consistency while cooling with ice using a Dispermat CA-40-C dissolver (from Getzmann) with a 40 mm toothed disk, then sheared for 60 s at 8400 rpm, then equilibrated for 60 min by means of ultrasound, and clear filtrate is separated off via pressure filtration after 2 days. The filtrate is evaluated with respect to silicon content by means of atomic absorption spectroscopy (AAS). Limit of detection <100 ppm of organosilicon compounds, based on silicic acid.

3. Relative viscosity
15 g of silicic acid are stirred in portions by means of a bead mill (Getzmann APS 250 and Dispermat CA-40-C with 2 mm ZrO₂ grinding beads) into 85 g of HDDA and then dispersed to a grindometer value of 0 μm (25 μm grindometer). The viscosity of the dispersion medium and of the dispersion are determined by means of a rheometer on air bearings and with a cone-plate sensor system at 25° C. at a shear rate of 10 s-1. The dispersion was stored for 24 h at room temperature before the measurement.

1-12. (canceled)

13. A modified pyrogenic silicic acid surface-modified with an organofunctional silicone resin layer of the formula I
(Y—(CH₂)ᵥ)_{w}Si(R¹)ₓ(OR²)_{y}O_{z/2} (I),
in which
R¹ is an optionally substituted Si—C-bonded C₁-C₂₀-hydrocarbon radical,
R² is a hydrogen atom or a hydrocarbon radical having the same meaning as R¹,
Y is a functional group —NR²₂, —OC(O)C(R)═CH₂ where (R═H), or a C₁-C₁₅-hydrocarbon radical,
v is 1, 2 or 3,
w+x+y+z=4, w, x, y and z being an integral or nonintegral number <4 wherein the organofunctional silicone resin layer consists of T groups and D groups, the ratio of T groups to D groups being 0.05 to 0.95:0.95 to 0.05, the ratio of the D¹ groups to D² groups being 0 to 0.9:0.1 to 1.0 and the sum of the intensities of T² and T³ groups being at least a factor 3 greater than the intensity of the T¹ groups by ²⁹Si NMR spectroscopy; or
wherein the organofunctional silicone resin layer consists of Q groups and D groups, the ratio of Q groups to D groups being 0.05 to 0.5:0.5 to 0.95; or wherein the organofunctional silicone resin layer consists of T groups, the sum of the intensities of the T² and T³ groups being at least a factor 3 greater than the intensity of the T¹ groups.

14. The modified pyrogenic silicic acid of claim 13, wherein the organofunctional silicone resin layer has a surface layer thickness L of greater than 0.9 nm.

15. The modified pyrogenic silicic acid of claim 13, which has a carbon content of greater than 2% by weight.

16. A process for the preparation of the modified pyrogenic silicic acid of claim 13, comprising adding water during surface modification and dispersing (1), reaction (2), drying (3) and optionally postreaction (4) of pyrogenic silicic acid with a silylating agent to surface modify the silicic acid with said resin layer is carried out in an atmosphere comprising less than 10% by volume of oxygen.

17. The process of claim 16, wherein the surface modification is effected with a temperature gradient, the product temperature being in a range of 20-180° C. at the beginning of the reaction and in a range of 120-300° C. at the end, with the proviso that the product temperature is lower at the beginning than at the end.

18. A coating, adhesive or sealant, comprising at least one modified pyrogenic silicic acid of claim 13.
